(19) United States
(12) Patent Application Publication
(10) Pub. No.: US 2024/0255183 A1
(43) Pub. Date: Aug. 1, 2024

(54) HEATING DEVICE AND METHOD FOR PRODUCING A HEATING DEVICE

(71) Applicant: STEGO Holding GmbH, Schwäbisch Hall (DE)

(72) Inventors: Susanne Luz, Waiblingen (DE); Ulrich Lerche, Michelfeld (DE); Elmar Mangold, Zöbingen, Unterschneidheim (DE)

(21) Appl. No.: 18/560,731

(22) PCT Filed: May 12, 2022
(86) PCT No.: PCT/EP2022/062946

§ 371 Date: Nov. 14, 2023

(30) Foreign Application Priority Data
May 14, 2021 (DE) 10 2021 112 603.7

(51) Int. Cl. F24H 9/1863; F24H 3/00; H05B 3/44

(52) U.S. Cl. CPC F24H 9/1872; F24H 3/002; H05B 3/44

(57) ABSTRACT

A heating device including at least one heating element, more particularly at least one PTC element; at least two current supply devices; and a heat exchanger body which has an outer surface for releasing heat to an environment and a receiving cavity for receiving the heating element; wherein the heating element is disposed in the receiving cavity and is thermally conductively connected to the heat exchanger body, and wherein at least one spring element is provided which is supported on at least one support region of the heat exchanger body and applies a clamping force toward the heating element such that the heating element is pressed against the current supply devices and a base, more particularly a heat sink, of the heat exchanger body.

### CROSS REFERENCE TO RELATED PATENT APPLICATIONS

This is a U.S. national phase patent application of PCT/EP2022/062946 filed May 12, 2022 which claims the benefit of and priority to German Patent Application No. 10-2021-112-603.7, filed on May 14, 2021, the entire contents of each of which are incorporated herein by reference.

### FIELD

The invention relates to a heating device and a method for producing a heating device.

### BACKGROUND

A heating device according to the preamble of claim 13 is known, for example, from DE 10 2006 018 150.

In control cabinets or in small enclosures, which also include camera housings or housings of valve devices, for example, temperature changes cause condensation to form, which together with dust and aggressive gases can cause corrosion. This increases the risk of operational failures due to leakage currents or flashovers. To ensure consistently optimal climatic conditions for the proper functioning of the components located in the control cabinet or the small housing, heaters or fan heaters are therefore used, in particular PTC semiconductor heaters, whose reliability and durability are subject to high demands.

Such heaters are usually equipped with electric heating elements. The mounting of these heating elements is intended to provide good heat transfer on the one hand and constant secure fixation on the other. The frequent and, depending on the operating conditions, large temperature changes can lead to material fatigue due to aging and thus to a reduction in the holding force with which the heating elements are fixed. As a result, heat transfer is degraded. If the holding function is completely eliminated, this can even lead to a total failure of the device.

In the initially mentioned DE 10 2006 018 150, for example, heating elements are arranged in a heat exchanger body. The heat exchanger body is plastically deformed in such a way that the heating elements are held therein. The heat exchanger body encloses the cavity for the heating elements.

### SUMMARY

The invention is based on the object of providing a heating device in which heating performance and operational reliability are increased by means of an improved design, and production is simplified. Furthermore, the invention is based on the object of providing a method for producing a heating device.

According to the invention, this object is solved with regard to the heating device by the subject matter of claim 13. With regard to the method, the above-mentioned object is solved by the subject matter of claim 24.

Specifically, this object is solved by a heating device having at least one heating element, in particular at least one PTC element, at least two current supply devices and a heat exchanger body. The heat exchanger body has an outer surface for releasing heat to an environment and a receiving cavity for receiving the heating element. The heating element is arranged in the receiving cavity and is connected to the heat exchanger body in a thermally conductive manner. In addition, at least one spring element is provided, which is supported on at least one support region of the heat exchanger body and applies a clamping force toward the heating element in such a way that the heating element is pressed against the current supply devices and a base, in particular a heat sink, of the heat exchanger body.

The invention has several advantages. The clamping force of the spring element securely presses the heating element against the power supply lines and the base of the heat exchanger body even in the event of material fatigue of the heat exchanger body, particularly in the area of the support region. The spring element thereby supports itself against the support region. In other words, the spring element rests against the support region for support. The spring element is therefore a separate element from the heat exchanger body. In other words, the spring element is structurally separate from the heat exchanger body. The support region forms an abutment for the spring element in order to apply the clamping force to the heating element or the current supply devices. These are pressed against the base of the heat exchanger body by the clamping force of the spring element. The clamping force of the spring element thus acts in the opposite direction to the support region of the heat exchanger body towards the heating element. Preferably, the heating element is pressed elastically, in particular resiliently, against the current supply devices and the base of the heat exchanger body by the spring element.

Furthermore, the operational reliability of the heating device according to the invention is increased, since the spring element compensates for tolerances occurring due to material fatigue, for example, and thus prevents the contact between the heating element and the current supply devices from loosening even in the event of increased fatigue. The risk of failure of the heating device is thus considerably reduced.

In general, material fatigue of the heat exchanger body, especially in the support region, can occur due to frequent and/or large temperature changes and thus lead to a reduction in the contact force with which the heating element is fixed. This is prevented in the heating device according to the invention by the clamping force of the spring element.

The invention has the further advantage that, by appropriate design of the spring element, the clamping force in the direction of the heating element and thus the contact force between the heating element and the current supply devices and the base of the heat exchanger body can be adjusted according to requirements. In other words, the use of the spring element enables different configurations of the heating device. The heating device can therefore be used in a variety of ways.

Due to the spring element, the heating element is in contact with the current supply devices with a constant contact force over the service life of the heating device, or the heating element is pressed against the base of the heat exchanger body with a constant contact force. As a result, the heating device has a constant heating power, whereby the temperature of the surroundings of the heating device can be controlled uniformly.

The heating element is preferably a PTC element. PTC stands for “Positive Temperature Coefficient” and means that the heating element in this design has a positive temperature coefficient. The PTC element can be described as a temperature-dependent resistance element.

The heating element is preferably indirectly pressed against the base of the heat exchanger body by at least one of the current supply devices. In other words, preferably at least one of the current supply devices is arranged between the heating element and the base of the heat exchanger body. Thus, there is no direct contact between the heating element and the base of the heat exchanger body. The base preferably forms a heat sink for temperature regulation of the heat exchanger body.

Preferably, the spring element is arranged in a pretensioned manner in and/or on the heat exchanger body, in particular in the direction of the heating element. The spring element is preferably connected to the heating element indirectly. In particular, at least one of the current supply devices can be arranged at least partially between the spring element and the heating element.

The support region can have at least one contact surface for the spring element. The support region is preferably a longitudinal leg of the heat exchanger body that extends in the longitudinal direction of the heating device. The support region can alternatively be designed as a tab.

The heating device thus has a longitudinal extension whose longitudinal direction is parallel thereto.

The spring element preferably rests at least in part against the support region. For this purpose, the spring element can have a lateral, in particular elongated contact section. The spring element can be in line contact and/or point contact and/or surface contact with the support region for support.

Preferred embodiments of the invention are given in the subclaims.

In a preferred embodiment, the heating element is sandwiched between the two current supply devices to form a sandwich package. In other words, the heating element and the current supply devices are sandwiched together with the heating element in between. This has the advantage that, when the heating device is manufactured, the individual layers can be easily inserted into the receiving cavity of the heat exchanger body. Alternatively, it is possible to preassemble the sandwich package before inserting it into the receiving cavity and then insert it therein. In general, the sandwich-like structure simplifies the manufacture of the heating device.

Preferably, the heating element is of plate-shaped design. The current supply devices preferably have at least one plate-shaped section that is in contact with the heating element.

In a particularly preferred embodiment, the spring element rests against an inner side of the support region facing the receiving cavity and braces the heating element and/or the current supply devices against the base, in particular the heat sink, of the heat exchanger body. This ensures a secure hold of the heating element or the sandwich package in the receiving cavity of the heat exchanger body.

Preferably, the spring element braces the heating element and the current supply devices against the base of the heat exchanger body. In other words, the spring element braces the sandwich package against the base of the heat exchanger body. The clamping force of the spring element thus acts indirectly on the base of the heat exchanger body. The inner side of the support region faces the heating element, so that the spring element applies the clamping force in the direction of the heating element. Thus, the inner side of the support region also faces the base of the heat exchanger body. The base of the heat exchanger body delimits the receiving cavity on the bottom side. Further preferably, the base has at least one mounting region for attaching the heating device to a counterpart, in particular an external holder device.

In summary, the heat exchanger body preferably has two side walls for the lateral boundary of the receiving cavity and the base for the bottom-side boundary of the receiving cavity. On a side opposite the base, the heat exchanger body is preferably designed to be open to the outside for receiving the spring element.

In another particularly preferred embodiment, the support region is formed by a tab which extends from at least one side wall of the heat exchanger body towards the center of the heat exchanger body and runs along a longitudinal direction of the side wall. Here, the tab forms the abutment for the spring element. The tabs form support regions on both sides which hold the spring element in the receiving cavity in a fixed position. The tabs thus hold the spring element and thus the sandwich package securely in the receiving cavity.

Particularly preferably, the tabs are bending tabs. In other words, the tabs are directed towards the center of the heat exchanger body during manufacture by bending, in particular by means of “caulk technology”. The tab may extend at least in sections in the longitudinal direction of the heating device. The tab may be of continuous design. Alternatively, the tab can be interrupted in sections.

In a preferred embodiment, the heating element is in contact with the current supply devices through at least one pressing surface. Thus, the heating element and/or the current supply devices can each have at least one pressing surface on which the heating element is in press contact with the current supply devices due to the clamping force of the spring element. The spring element preferably applies the clamping force transverse to the pressing surface to the heating element and/or at least one of the current supply devices. In other words, the line of action of the clamping force extends normal to the at least one contact pressure surface of the heating element and/or the current supply devices. Particularly preferably, the spring element applies the clamping force transverse to the pressing surface to the heating element and both current supply devices. In this case, the clamping force is introduced as efficiently as possible into the heating element and/or the current supply devices so that an increased heating power results.

Preferably, the heat exchanger body has two oppositely arranged side walls, on each of which the support region for the spring element is formed. In other words, the heat exchanger body has two oppositely arranged support regions against which the spring element is supported. The side walls laterally delimit the receiving cavity. In this embodiment, the spring element rests against two support regions of the heat exchanger body. This ensures stable support contact between the spring element and the heat exchanger body and distributes the support force of the spring element, which corresponds to the clamping force, over two support points.

In a preferred embodiment, at least one pressing part is arranged between the spring element and one of the current supply devices. The pressing part preferably transmits the clamping force from the spring element to the heating element and/or to at least one of the current supply devices, in particular to the sandwich package. The pressing part serves as a force transmission element to transfer the clamping force gently and evenly distributed, in particular over a wide area, to the adjacent current supply device. This increases the service life of the heating device.

The pressing part is preferably of plate-shaped design. The pressing part preferably has a concave shape in a region facing the spring element, against which the spring element rests. As a result, the pressing part absorbs the spring force or the clamping force of the spring element more effectively. The pressing part can be designed as a solid material. Alternatively, the pressing part can be formed as a structural part with cavities. Preferably, the pressing part is made of aluminum.

In a preferred embodiment, the spring element is arc-shaped in cross-section. The spring element preferably has an apex region that faces the heating element for transmitting the clamping force. The curved shape of the spring element means that the clamping force is transmitted in a particularly targeted manner via the apex region to the adjacent element, in particular the pressing part. Furthermore, this allows the spring element to be pretensioned against the adjacent element in a simple manner, namely by bending the tabs inwards, i.e. towards the center, after the spring element has been inserted into the receiving cavity. This elastically deforms the spring element.

Preferably, the spring element is a leaf spring. Additionally or alternatively, the respective current supply device comprises an electrode. The electrode may be an aluminum electrode. Additionally or alternatively, the heat exchanger body may consist of aluminum. Here, it is advantageous that the components are inexpensive to manufacture and thus reduce the overall cost of the heating device.

In a preferred embodiment, the receiving cavity is closed at the end by at least one cover, in particular made of plastic. The cover preferably engages positively at least in sections in an inner contour of the heat exchanger body. Preferably, both end faces of the receiving cavity are closed by a cover in a form-fitting manner, in particular a self-clamping manner. The inner contour of the heat exchanger body can have several round recesses in which the cover engages. For this purpose, the cover preferably has polygonal extensions which are in line or point contact with the respective recess. Here it is advantageous that additional fastening means, such as screws, clamping devices, etc., can be omitted. Furthermore, the polygonal extensions of the cover fitted into the round recesses form a stable and firm one-time connection of the cover to the heat exchanger body. During the connection, the polygonal extensions of the cover are pressed into the round recesses, forming a press-fit connection. Increased friction values are present between the polygonal extensions and the round recesses. In addition, any existing tolerances are compensated for.

Preferably, at least one insulating device is arranged between the heat exchanger body and the sandwich package. Preferably, the sandwich package is at least partially, in particular completely, sheathed with an insulating foil.

According to the alternative independent claim 24, the invention relates to a method for producing a heating device, in particular according to a heating device according to the invention, in which
at least one heating element, at least two power supply devices, and a heat exchanger body having a receiving cavity are provided;
the heating element is arranged between the two current supply devices to form a sandwich package, which is then sheathed with an insulating foil;
the sandwich package is inserted into the receiving cavity in such a way that the heating element is in connection with the heat exchanger body in a thermally conductive manner;
at least one spring element, in particular a leaf spring, is inserted into the receiving cavity; and
at least one support region of the heat exchanger is plastically deformed, in particular bent over, to pretension the spring element in such a way that the spring element applies a clamping force in the direction of the heating element and presses the heating element against the two current supply devices and a base, in particular a heat sink, of the heat exchanger body.

Due to the plastic deformation of the heat exchanger body, specifically of the support region, the clamping force of the spring element can be advantageously adjusted. The clamping force of the spring element depends on the degree of plastic deformation, in particular the bending angle of the support region after bending. Furthermore, the plastic deformation has the advantage of enabling tolerance compensation between the spring element and the heat exchanger body as well as a pressing part. In addition, it allows for interference-free assembly and increased curvature of the spring element, which results in improved tension on the spring element and thus increased thermal performance.

With regard to the advantages of the method for producing a heating device, reference is made to the advantages explained in connection with the heating device. Furthermore, the method may alternatively or additionally have individual or a combination of several features previously mentioned with respect to the heating device.

### BRIEF DESCRIPTION OF THE DRAWINGS

The invention is explained in more detail below with reference to the accompanying drawings. The embodiments shown represent examples of how the heating device according to the invention can be designed.

The drawings show as follows:

FIG. 1 shows a perspective view of a heating device according to a preferred exemplary embodiment of the invention;

FIG. 2 shows a cross-section through the heating device according to FIG. 1; and

FIG. 3 shows a longitudinal section through the heating device according to FIG. 1.

### DESCRIPTION OF AN EMBODIMENT

In the following, the same reference numerals are used for identical and identically acting parts.

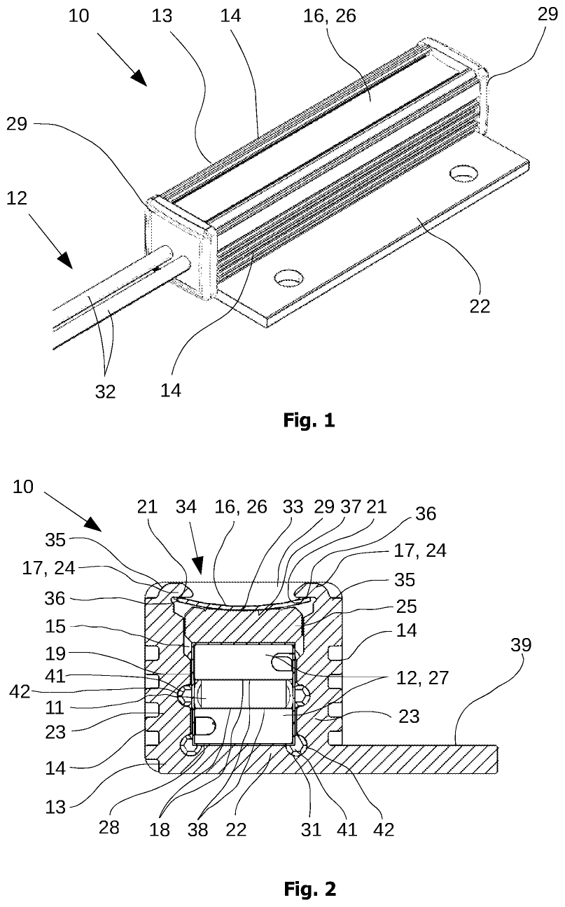

FIG. 1 shows a heating device 10 according to a preferred embodiment according to the invention. The heating device 10 has a heating element 11, two current supply devices 12 and a heat exchanger body 13. Furthermore, a spring element 16 is provided which applies a clamping force in the direction of the heating element 11 and thus ensures a press contact between the heating element 11 and the two current supply devices 12. The spring element 16 will be discussed in more detail below.

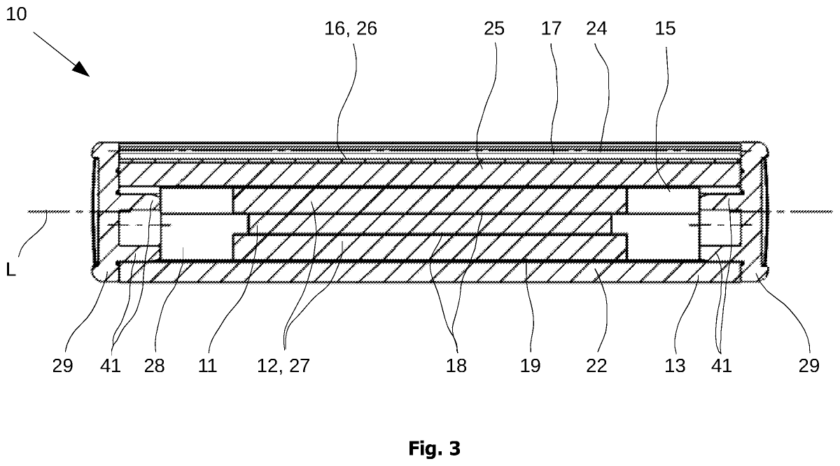

The heat exchanger body 13 comprises an outer surface 14 with longitudinal fins and a receiving cavity 15. The outer surface 14 is used to transfer heat to the environment. The heat exchanger body 13 is thermally conductively connected to the heating element 11 for heat transfer. The receiving cavity 15 receives the heating element 11. Furthermore, current supply devices 12 are partially arranged in the receiving cavity 15. This can be seen clearly in FIGS. 2 and 3. The current supply devices 12 will be discussed in more detail below.

The heat exchanger body 13 has a base 22 and two oppositely arranged side walls 23. The side walls 23 are formed to protrude from the base 22. The side walls 23 laterally bound the receiving cavity 15 and the base 22 bounds the receiving cavity 15 on the bottom side. Together, the side walls 23 and the base 22 form a U-shaped profile. The receiving cavity 15 is thus bounded on three sides. Furthermore, the receiving cavity 15 is open to the outside on a side 34 of the heat exchanger body 13 opposite the base 22. The side walls 23 each have a free end 35. The free ends 35 of the side walls 23 are located on the opposite side 34.

The heat exchanger body 13 is an extruded section. The side walls 23 and the base 22 are formed integrally with each other.

FIGS. 1 and 3 show that the heat exchanger body 13 is elongated. In other words, the heat exchanger body 13 has a longitudinal extension. The heat exchanger body 13 has a longitudinal axis L that extends centrally between the two side walls 23 in the longitudinal direction of the heat exchanger body 13.

As shown in FIGS. 2 and 3, the heating element 11 and the current supply devices 12 are arranged in the receiving cavity 15. The current supply devices 12 each include an electrode 27. The electrodes 27 comprise aluminum. Other electrode materials are possible. The electrodes 27 are of plate-shaped design.

Further, the current supply devices 12 each comprise an electrical lead 32 connected to the associated electrode 27. The electrodes 27 each have a longitudinal side at which a U-shaped recess is formed. The recess preferably serves to receive and connect terminals of the electrical leads 32. The recesses of the two electrodes 27 are offset from one another transversely to the longitudinal direction of the electrodes 27. For this purpose, the electrodes 27 are arranged rotated relative to one another, i.e. folded over, in particular because of the routing of the leads 32 and any accumulations of material. The electrodes 27 are contacted at the end faces in order to realize the flatness of the electrodes 27, in particular plate-shaped electrodes 27. Due to the planar shape of the electrodes 27, the heat output is increased. The connection of the leads 32 to the electrodes 27 is not shown in FIGS. 1 to 3.

The heating element 11 according to FIGS. 1 to 3 is a PTC element. In other words, the heating element 11 has a positive temperature coefficient. Hereinafter, the heating element 11 will be referred to as the PTC element 11. As can be readily seen in FIGS. 2 and 3, the PTC element 11 is disposed between the two electrodes 27. The PTC element 11 is of plate-shaped design. The PTC element 11 is formed smaller in its outer dimensions on the narrow sides than the electrodes 27. In other words, the PTC element 11 has an outer contour that is circumferentially offset inwardly from an outer contour of the electrodes 27, in particular toward its own center.

Specifically, the electrodes 27 form a sandwich package 19 with the PTC element 11 arranged therebetween, thereby considerably simplifying the manufacture or assembly of the heating device 10. The sandwich package 19 is arranged lying in the receiving cavity 15. The PTC element 11 and the electrodes 27 are each of elongated design. The PTC element 11 and the electrodes 27 extend in the longitudinal direction of the heat exchanger body 13.

Furthermore, the heating device 10 comprises the aforementioned spring element 16. The spring element 16 is a leaf spring 26. The leaf spring 26 is a separate or distinct spring element. In other words, the leaf spring 26 is structurally separate from the heat exchanger body 13. The leaf spring 26 is arcuate in cross-section. In other words, the leaf spring 26 is cup-shaped. Specifically, the leaf spring 26 has a convex shape in the direction of the heating element 11. The leaf spring 26 includes an apex region 33 that forms a clamping force transmitting section in the direction of the heating element 11. Further, the leaf spring 26 includes two lateral contact sections 36 with which the leaf spring 26 is supported against support regions 17 of the heat exchanger body 13. The support regions 17 will be discussed in more detail below.

The lateral contact sections 36 are lateral ends of the leaf spring 26 that face each other. The lateral contact sections 36, in particular the lateral ends, extend in the longitudinal direction of the heat exchanger body 13. The leaf spring 26 is of elongated design. The leaf spring 26 extends in the longitudinal direction of the heat exchanger body 13. In other words, the leaf spring 26 extends parallel to the side walls 23. The leaf spring 26 is disposed in the receiving cavity 15. Specifically, the leaf spring 26 is arranged on the side 34 opposite the base 22. The leaf spring 26 spans the receiving cavity 15 in the longitudinal direction of the heat exchanger body 13.

As mentioned above, the heat exchanger body 13 has the support regions 17 on the side walls 23 for abutment of the lateral contact sections 36 of the leaf spring 26. The support regions 17 are formed by tabs 24 which are bent inwardly transversely to the longitudinal direction on the side walls 23. In other words, the tabs 24 are folded over by bending. The tabs 24 may also be referred to as bending tabs. The tabs 24 are part of the side walls 23. The tabs 24 each have an inner side 21 facing the base 22. The leaf spring 26 with the lateral contact sections 36 rests against this inner side 21 for support.

By bending the tabs 24, the clamping force of the leaf spring 26 can be adjusted. The clamping force of the leaf spring 26 depends on the bending angle of the tabs 24, with which the tabs 24 are bent inward. Furthermore, the tabs 24 have the advantage of allowing tolerance compensation between the leaf spring 26 and the heat exchanger body 13 and the pressing part 25 described later. Additionally, an interference-free assembly as well as an increased curvature of the leaf spring 26 is made possible, resulting in an improved tension of the leaf spring 26 and thus an increased heat output.

A pressing part 25 is arranged between the leaf spring 26 and the sandwich package 19. The pressing part 25 absorbs the clamping force from the leaf spring 26 and transfers the absorbed clamping force to the adjacent electrode 27. The pressing part 25 has a surface 37 facing the spring element 16, in particular the leaf spring 26, which is in contact with the apex region 33. The surface 37 of the pressing part 25 has a partially curved shape for contacting the apex region 33 of the leaf spring 26. Specifically, the surface 37 of the pressing part 25 has a concave shape. Alternatively, the surface 37 has a flat shape, that is, free of a curvature. Furthermore, the pressing part 25 has notches on the surface 37.

The pressing part 25 is arranged in abutment with an inner contour 31 of the heat exchanger body 13 or at a slight distance therefrom. Specifically, the pressing part 25 can rest against the opposing side walls 23. In this way, a positionally precise arrangement of the pressing part 25 in the receiving cavity 15 is achieved. The pressing part 25 is arranged to be movable in the direction of the clamping force. Furthermore, the pressing part 25 has a chamfer on longitudinal edges. The pressing part 25 is of plate-shaped design. The pressing part 25 is made of a solid material. Specifically, the pressing part 25 is made of aluminum.

As shown in FIG. 2, the sandwich package 19 is surrounded by an insulating device 28. Specifically, the sandwich package 19 is completely encased with an insulating foil. The insulating foil is thus arranged between the pressing part 25 and the heat exchanger body 13 and the sandwich package 19 for electrical insulation.

In the following, the arrangement of the aforementioned individual components of the heating device 10 with the heat exchanger body 13 is described starting from the base 22 along an imaginary axis which is perpendicular to the base 22.

As can be seen clearly in FIG. 2, the insulating foil is arranged between the base 22 and a first of the two electrodes 27. The first electrode 27 lies flat against the insulating foil. The PTC element 11 is arranged adjacent to the first electrode 27, with a second of the two electrodes 27 again resting flat against it. The pressing part 25 is then arranged, with the insulating foil being located between the pressing part 25 and the second electrode 27. The pressing part 25 is in contact with the leaf spring 26, specifically with the apex region 33 of the leaf spring 26, on the side 34 of the heat exchanger body 13 opposite the base 22. The leaf spring 26 and the pressing part 25 are in direct contact for force transmission. To apply the clamping force, the leaf spring 26 rests against the two tabs 24 of the heat exchanger body 13 with the lateral contact sections 36.

The leaf spring 26 rests against the inner sides 21 of the two tabs 24 to apply the clamping force in opposite directions with respect to the tabs 24. The tabs 24 partially protrude over the lateral contact sections 36 of the leaf spring 26 toward the center, in particular in the direction of the longitudinal axis L. The tabs 24 therefore each form an abutment for the lateral contact sections 36 of the leaf spring 26. The leaf spring 26 is elastically deformed between the pressing part 25 and the tabs 24 for pretensioning. Specifically, when the heating device 10 is manufactured, the leaf spring 26 is first pressed against the pressing part 25 when the tabs 24 are folded down or bent over toward the leaf spring 26, and is thus pretensioned. The force flow of the clamping force is from the leaf spring 26 via the apex region 33 to the pressing part 25, from the pressing part 25 to the sandwich package 19 and then to the base 22 of the heat exchanger body 13. In other words, the leaf spring 26 clamps the sandwich package 19 against the base 22 via the pressing part 25, thus keeping the integrated components stable and fixed in the receiving cavity 15. The insulating foil is not mentioned here for reasons of simplicity.

Due to the clamping force of the leaf spring 26, the PTC element 11 and the electrodes 27 are pressed against each other. This increases the heating power of the heating device 10 compared to conventional known PTC heating element configurations. The clamping force of the leaf spring 26 extends transversely to two pressing surfaces 18 of the PTC element 11, via which the PTC element 11 is in pressing contact with adjacent pressing surfaces 38 of the respective electrodes 27. The electrodes 27 and the PTC element 11 are in direct contact.

To achieve temperature regulation of the heating device 10, the base 22 forms a heat sink. As shown in FIG. 1, the base 22 is plate-shaped. The base 22 protrudes outwardly transversely to the longitudinal direction beyond one of the side walls 23. This protruding portion of the base 22 forms a mounting region 39 for mounting the heating device 10, for example, to an external support device. The mounting region 39 has at least two through openings.

According to FIG. 1, the heating device 10 has a total of two covers 29 which close the receiving cavity 15 at its end faces. On one of the covers 29, the electrical leads 32 of the current supply devices 12 are led to the outside, in particular sealed.

The covers 29 serve to increase the suitability of the heating device 10 for various environmental conditions, for example humid and/or dusty environments. Due to the covers 29, the heating device 10 has an increased IP protection.

The covers 29 each have projections 41 that extend from a transverse side of the covers 29. The projections 41 each have a polygonal contour. Specifically, the projections 41 form polygonal pins which engage in round recesses 42 of the inner contour 31 of the heat exchanger body 13 for fastening the covers 29. In this context, the edges of the projections 41 are in line contact with surfaces of the recesses 42. As shown in FIG. 2, the inner contour 31 of the heat exchanger body 13 has a total of four recesses 42 and the respective cover 29 has four projections 41. Such a plug-in connection is particularly advantageous in terms of durability and ease of assembly. In addition, the covers 29 can be bonded to the heat exchanger body 13. FIG. 3 further shows that the sandwich package 19 is spaced longitudinally from the two covers 29.

### LIST OF REFERENCE SIGNS

10 Heating device
11 Heating element, PTC element
12 Current supply devices
13 Heat exchanger body
14 Outer surface
15 Receiving cavity
16 Spring element
17 Support region
18 Pressing surface of the heating element
19 Sandwich package
21 Inner side of the support region
22 Base
23 Side walls
24 Tab
25 Pressing part
26 Leaf spring
27 Electrode
28 Insulation device
29 Cover
31 Inner contour of the heat exchanger body
32 Electrical leads
33 Apex region
34 Side opposite the base
35 Free end
36 Lateral contact sections
37 First surface
38 Pressing surfaces of the electrodes
39 Mounting region
41 Projections
42 Recesses
L Longitudinal axis

1-12. (canceled)

13. A heating device comprising:
at least one heating element;
at least two current supply devices; and
a heat exchanger body which has an outer surface for releasing heat to an environment and a receiving cavity for receiving the at least one heating element, wherein the at least one heating element is arranged in the receiving cavity and is connected to the heat exchanger body in a thermally conductive manner, wherein at least one spring element is provided, which is supported on at least one support region of the heat exchanger body and applies a clamping force toward the at least one heating element in such a way that the at least one heating element is pressed against the at least two current supply devices and a base of the heat exchanger body.

14. The heating device according to claim 13, wherein the at least one heating element is arranged between the at least two current supply devices to form a sandwich package.

15. The heating device according to claim 13, wherein the at least one spring element rests against an inner side of the at least one support region facing the receiving cavity and braces the at least one heating element and/or the at least two current supply devices against the base of the heat exchanger body.

16. The heating device according to claim 13, wherein the at least one support region is formed by a tab which extends from at least one side wall of the heat exchanger body towards a center of the heat exchanger body and runs along a longitudinal direction of the side wall.

17. The heating device according to claim 13, wherein the at least one heating element is in contact with the at least two current supply devices through at least one pressing surface, wherein the at least one spring element applies the clamping force transverse to the pressing surface to the at least one heating element and/or at least one of the at least two current supply devices.

18. The heating device according to claim 13, wherein the heat exchanger body has two oppositely arranged side walls, on each of which the at least one support region for the at least one spring element is formed.

19. The heating device according to claim 13, wherein at least one pressing part is arranged between the at least one spring element and one of the at least two current supply devices, wherein the pressing part transmits the clamping force from the at least one spring element to the at least one heating element and/or to at least one of the at least two current supply devices.

20. The heating device according to claim 13, wherein the at least one spring element is arc-shaped in cross-section and has an apex region that faces the at least one heating element for transmitting the clamping force.

21. The heating device according to claim 13, wherein the at least one spring element is a pretensioned leaf spring and/or a respective one of the at least two current supply devices further comprises an electrode.

22. The heating device according to claim 13, wherein the receiving cavity is closed at an end by at least one cover, wherein the at least one cover engages positively at least in sections in an inner contour of the heat exchanger body.

23. The heating device according to claim 14, wherein at least one insulating device is arranged between the heat exchanger body and the sandwich package.

24. A method for producing the heating device according to claim 13, the method comprising steps of:
the at least one heating element, the at least two current supply devices, and the heat exchanger body having the receiving cavity are provided;
the at least one heating element is arranged between the at least two current supply devices to form a sandwich package, which is then sheathed with an insulating device;
the sandwich package is inserted into the receiving cavity in such a way that the at least one heating element is in connection with the heat exchanger body in a thermally conductive manner;
the at least one spring element is inserted into the receiving cavity; and
the at least one support region of the heat exchanger is plastically deformed to pretension the at least one spring element in such a way that the at least one spring element applies the clamping force in a direction of the at least one heating element and presses the at least one heating element against the at least two current supply devices and a base of the heat exchanger body.
